(19) United States
(12) Patent Application Publication
(10) Pub. No.: US 2013/0057636 A1
(43) Pub. Date: Mar. 7, 2013

(54) PRINTER AND PRINTING CONTROL METHOD THEROF

(71) Applicant: Takahisa Iwaki, Shizuoka-ken (JP)

(72) Inventor: Takahisa Iwaki, Shizuoka-ken (JP)

(73) Assignee: TOSHIBA TEC KABUSHIKI KAISHA, Tokyo (JP)

(21) Appl. No.: 13/571,623

(22) Filed: Aug. 10, 2012

(30) Foreign Application Priority Data
Sep. 2, 2011 (JP) 2011-191782

(51) Int. Cl. B41J 2/35

(52) U.S. Cl. 347/211

(57) ABSTRACT

A printer comprises a multiple printing units, a power supply configured to provide power to the multiple printing units and a printing control unit configured to execute printing in the speed of being that at least one printing unit slower than the fastest printing speed thereof, when the multiple printing units executes printing simultaneously.

### CROSS-REFERENCE TO RELATED APPLICATION

This application is based upon and claims the benefit of priority from Japanese Patent Application No. 2011-191782, filed Sep. 2, 2011, the entire contents of which are incorporated herein by reference.

### FIELD

The embodiments described herein relate to a printer and a printing control method thereof.

### BACKGROUND

For example, it is well-known that an apparatus utilizes a control unit to control more than two printing units. In this apparatus, a device which accepts the power provided by one power supply to drive more than two printing units is configured.

### BRIEF DESCRIPTION OF THE DRAWINGS

FIG. 1 is a block diagram showing hardware in this embodiment;

FIG. 2 is a flow chart showing the processing at the beginning of printing of a printer in this embodiment;

FIG. 3 is a flow chart showing the processing at the end of printing of the printer.

### DETAILED DESCRIPTION

According to one embodiment, a printer comprises a multiple printing units, a power supply configured to provide power to the multiple printing units and a printing control unit configured to execute printing in the speed of being that at least one printing unit slower than the fastest printing speed thereof, when the multiple printing units executes printing simultaneously.

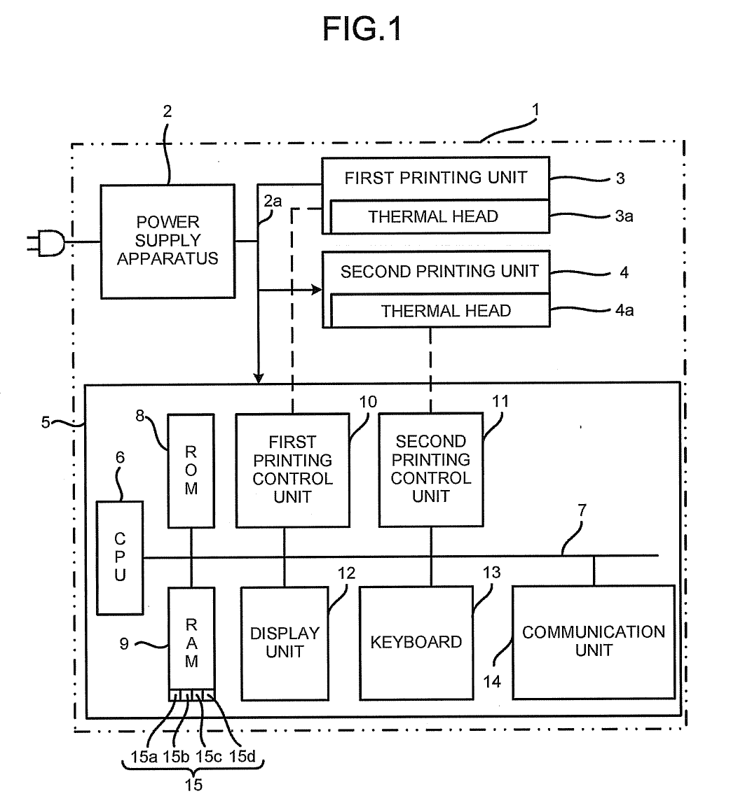

The embodiment of the printer will be illustrated with reference to FIG. 1-FIG. 3.

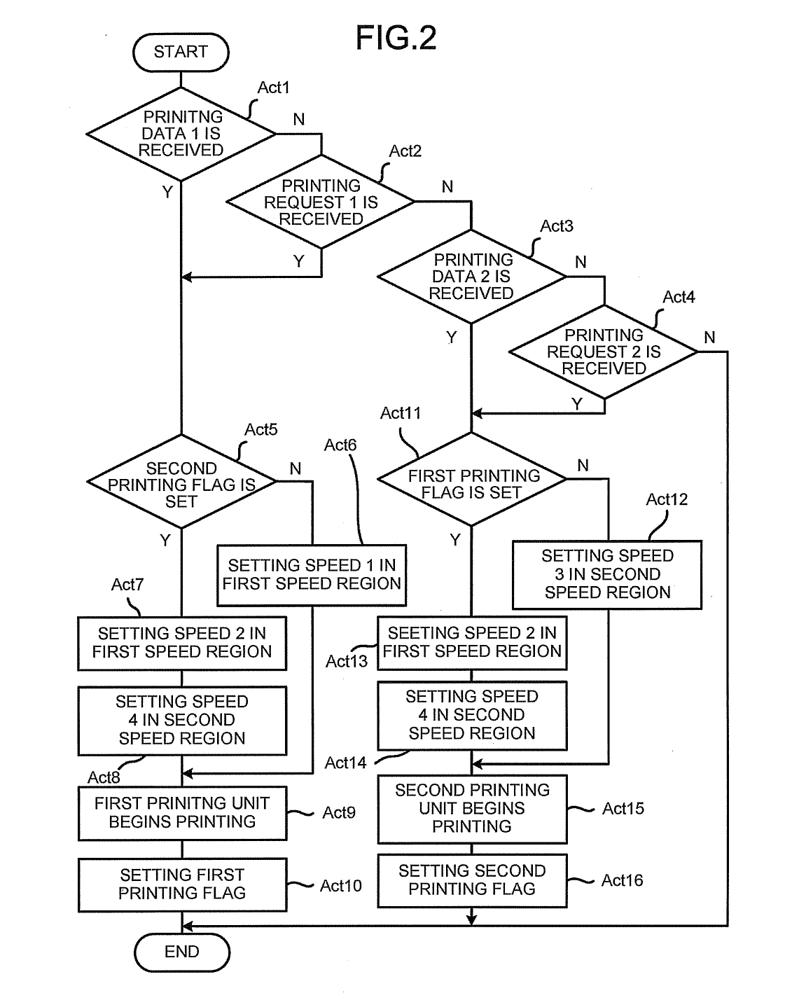

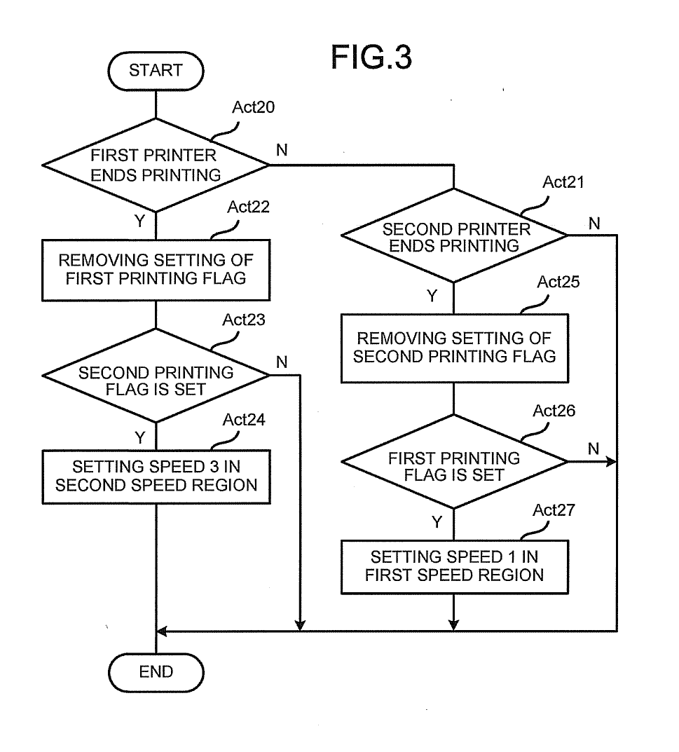

FIG. 1 is a block diagram showing the hardware in this embodiment, FIG. 2 is a flow chart showing the processing at the beginning of printing of a printer according to this embodiment, and FIG. 3 is a flow chart showing the processing at the end of printing of the printer.

The printer 1 provides power to a first printing unit 3, a second printing unit 4 and a control unit 5 by a power supply apparatus 2 which accepts commercial power supply via a power supply line 2a. Further, the first printing unit 3 and the second printing unit 4 execute printing respectively to paper by utilizing thermal heads 3a. 4a. In addition, in case that the first printing unit 3, the second printing unit 4 and the control unit 5 each needs different voltage, output by forming the different voltages in the power supply apparatus 2 or supply by making the power supply apparatus 2 into a suitable voltage and setting a voltage conversion device which may converse the voltage of the power supply apparatus for other units.

The control unit 5 is primarily used for controlling the first printing unit 3 and the second printing unit 4 and a CPU (Central Processing Unit) 6 and connects with a ROM (Read Only Memory) 8, a RAM (Random Access Memory) 9, and a first printing control circuit 10, a second printing control circuit 11, a display unit 12, a key board 13 and a communication unit 14. The CPU 6 executes Action according to the procedure stored in ROM, thus controlling each unit. ROM 8 stores the fixed data of such as the aftermentioned process program. RAM 9 particularly has the aftermentioned region 15, and further activates as a work region which is needed by the Action of the CPU 6, a buffer which temporarily stores the printing information or a communication buffer which temporarily stores the information received through the communication unit 14.

In the region 15 of the RAM 9, a printing flag 15a which stores whether the first printing unit 3 is in print, a first speed region 15b which sets the printing speed of the first printing unit 3, a second printing flag 15c which stores whether the second printing unit 4 is in print, and a second speed region 15d which sets the printing speed of the second printing unit 4 are configured. The first printing unit 3 executes printing in the speed set by the first speed region 15b and the second printing unit 4 executes printing in the speed set by the second speed region 15d. Moreover, the so-called printing speed is the transferring speed of paper.

The first printing control circuit 10 controls the first printing unit 3. The second printing control circuit 11 controls the second printing unit 4. The display unit 12 becomes a touch panel formed by integrating with the key board 13 and displays various information. The key board 13 comprises ten keys or various keys, which may indicate the printing of the first printing unit 3 or the second printing unit 4. The communication unit 14 connects to an ambient computer via such as the LAN circuits, and acquires information including printing information from the ambient computer.

The printer executes the processing at each fixed time shown in the FIG. 2. FIG. 2 is a view showing the processing at the beginning of the printing of the first printing unit 3 or the second printing unit 4. First, determine whether or not the communication unit 14 receives a printing data 1 (Act 1) for the printing of the first printing unit 3, and if the printing data 1 is not received, then determine whether or not a printing request 1 for the first printing unit 3 is received from the keyboard 13 (Act 2). Then, at the time of determining that a printing request 1 is not received for the first printing unit 3, determine whether or not the communication unit 14 receives a printing data 2 for the printing of the second printing unit (Act 3), and if the printing data 2 is not received, determine whether or not a printing request for the second printing unit 4 is received from the keyboard 13 (Act 4).

In the case of determining no printing data 1 received in Act 1, no printing request 1 in Act 2, no printing data 2 received in Act 3, and no printing request 2 in Act 4, end the processing.

When there is a printing data 1 received in Act 1 or a printing request 1 from the keyboard 13 in Act 2, by the set of the second printing flag 15c, determine whether or not the second printing unit 4 is in printing (Act 5), and if the second printing unit 4 is not in printing, to set the printing speed of the first printing unit 3 to the printable fastest printing speed 1 thereof, the first speed region 15b is set to the printing speed 1 (Act 6). If in Act 5 a second printing flag 15c is set, that is, the second printing unit 4 is in printing, thus the first speed region 15b is set to a printing speed 2 (Act 7), and to make the printing speed of the second printing unit 4 change from the fastest printing speed 3 thereof to a printing speed 4 slower than the printing speed 3, the second speed region 15d is set to a printing speed 4 (Act 8). In case that the printing speed of the first printing unit 3 and the second printing unit 4 is set, start the printing of the first printing unit 3 (Act 9), and to show that the first printing unit 3 is in printing a first printing flag 15a is set (Act 10), and end the processing.

At the time of the determining a printing data 2 received in Act 3 or a printing request 2 in Act 4, by detecting whether there is a first printing flag 15a set, determine whether or not the first printing unit 3 is in printing (Act 11), and if the first printing unit 3 is not in printing, the printing speed 3 is set in the second speed region 15d (Act 12). If a printing flag 15a is set in Act 11, that is, the first printing unit 3 is in printing, to make the printing speed of the first printing unit 3 change from the printing speed 1 to the printing speed 2, the first speed region 15b is set to the printing speed 2 (Act 13), and the second speed region 15d is set to the printing speed 4 (Act 14). If the printing speed of the first printing unit 3 and the second printing unit 4 is set, start the printing of the second printing unit 4 (Act 15), set a second printing flag 15c (Act 16) and end the processing.

Herein, the processing of the staring printing of the first printing unit 3 in Act 9, and the processing of the staring printing of the second printing unit 4 in Act 15 are the processing of the making each printing unit start printing. In addition, there is no record in the procedure, and if either of the reception of the printing data 1 in Act 1 or the entered printing request 1 in Act 2 has a printing request, depict the information for the printing of the first printing unit 3 in a depiction buffer of RAM 9. Either the first printing control unit 10 or the second printing control unit 11 provides the data stored in the depiction buffer to either the first printing unit 3 or the second printing unit 4.

Due to the processing in FIG. 3 executed by CPU 6 at each fixed time, the processing relates connects the ending of printing units. Determine whether or not the printing of the first printing unit 3 ends (Act 20), and if the printing of the first printing unit 3 does not end, determine whether or not the printing of the second printing unit 4 ends (Act 21). If the printing of the second printing unit 4 does not end, end the processing.

If the printing of the first printing unit 3 ends in Act 20, the set of the first printing flag 15a is removed (Act 22), and then determine whether or not the second printing flag 15c is set (Act 23). If the second printing flag 15c is not set, the second printing unit 4 is not in printing, thus ending the processing, and if the second printing flag 15c is set, to increase the printing speed of the second printing unit 4, the second speed region 15d is set to the printing speed 3 (Act 24), thus ending the processing. Moreover, the determination of whether or not the printing of the first printing unit 3 ends in Act 20 may be made by the ending flagal output by the first printing unit 3 through the first printing control unit 10. For example, when the printing of printing information ends or the delivery ends, the first printing unit 3 outputs an ending flagal.

When Act 21 determines the ending of the printing of the second printing unit 4, the set of the second printing flag 15c is removed (Act 25), thereby determining whether the first printing unit 3 is in printing, that is, the first printing flag 15a is set (Act 26). If the first printing flag 15a is not set, end the processing, and if the first printing flag 15a is set, to make the first printing unit 3 in the printing speed 1, the first speed region 15b is set to the printing speed 1 (Act 27), and end the processing. Same as the Act 20, the determination of the Act 21 is made according to the ending flagal of the second printing unit 4.

In the printer 1, the supply apparatus 2 provides power to the first printing unit 3, the second printing unit 4 and the control unit 5 of the printer 1. The power supplied by the power supply apparatus 2 is less than the total of each max power consumption of the three units thus forming the features: at the time of the first printing unit 3 and the second printing unit 4 executes printing simultaneously, decrease the power consumption of these printing units, thus executing printing by utilizing the power supply apparatus 2 with a small power supply capacity.

Thereby, the first printing unit 3 and the second printing unit 4 may execute printing in different printing speeds. For example, the first printing unit 3 may execute printing in a fastest printable speed of ten inches per second, and the second printing unit 4 may execute printing in a fastest printable speed of six inches per second. When the first printing unit 3 and the second printing unit 4 respectively execute a flagal printing, namely, when the printing is not executed simultaneously, each printing unit may execute printing in a fastest printable printing speed, but when the printing is executed simultaneously, by decreasing the printing speed of at least a printing unit, the power consumption of the two printing units is decreased, thus utilizing the supply apparatus with less capacitance to execute printing. The datum of the decreased printing speed of the printing unit is the speed being such as approximately

50% to 70% of the fastest printing speed. For example, if the fastest printing speed is ten inches per second, the printing speed is approximately five inches per second or seven inches per second. The printing speed of these printing units is properly determined according to the decreased power consumption due to slowing down the printing speed and the capacitance.

The printer 1 may execute printing by receiving printing data via the communication unit 14 from the ambient computer, and may also execute printing by the inputting of the keyboard 13 of the touch panel. Further, the printer 1 monitors whether or not the communication unit 14 receives a printing data at each fixed time or a printing command from the keyboard 13. If the printing data 1 is received, or the printing request 1 is input, the determination that there is a printing command for the printing of the first printing unit 3 is made. Moreover, by detecting whether or not a second printing flag 15c is set, determine whether the second printing unit 4 is in printing, and if the second printing unit 4 is not in printing, then only the first printing unit 3 is in printing and the first speed region 15b is set to a speed 1 being 10 inches per second as an example. If the second printing unit 4 is in printing, due to the insufficient capacitance of the power supply apparatus 2 when the first printing unit 3 and the second printing unit 4 execute printing in the fastest speed, the printing speed of the first printing unit 3 is set to the printing speed 2 being for example five inches per second. In addition, the second printing unit 4 executes printing in the fastest printing speed 3 being for example six inches per second until the first printing unit 3 begins printing, but the second speed region 15d is set to the printing speed 4 being for example three inches per second. Further, an in-printing flag which the first printing flag 15a indicates when the first printing unit 3 starts printing is set. In addition, the printing speed of the second printing unit 4 is changed to the printing speed set by the second speed region in the printing processing and then continues printing in the changed printing speed.

On the other hand, when the communication unit 14 receives the printing data 2 or the printing request 2 from the keyboard 13, the second printing unit 4 begins printing. First, by detecting whether or not a first printing flag 15a is set, the determination of whether the first printing 3 is in printing is made, and if the first printing flag 15a is not set, the fastest printing speed 3 of the second printing unit 4 is set to the second speed region 15d. If the first printing unit 3 is in printing, to slow down the printing speed of the first printing unit 3, the first speed region 15b is set to the speed 2 and the second speed region 15d is set to the speed 4. A second printing flag 15c which indicates when the set of the second speed region 15d ends, the second printing unit 4 begins printing and is in printing is set and then end the processing.

In addition, the printer 1 executes the next Action during some fixed time periodically. First, determine whether or not the printing of the first printing unit ends. The determination may be made by the information showing ending of the printing sent from the first printing unit 3. Moreover, the same way may be applied to determine whether the printing of the second printing unit 4 ends or not. If the printing of the first printing unit 3 ends, the set of the first printing flag 15a is removed; and then to determine whether the second printing unit 4 is in printing, detect a second printing unit 15c and if the second printing unit 15c is not set, end the processing. If the second printing unit 15c is set, to set the printing speed of the second printing unit 4 the fastest speed, the second speed region 15d is set to the speed 3, thus ending the processing.

If the printing of the second printing unit 4 ends, the set of the second printing flag 15c is removed; and by detecting the first printing flag 15a, determine whether the first printing unit 3 is in printing or not. If the first printing unit 3 is not in printing, end the processing, and if the first speed region 15b is set to the printing speed 1 when in printing, end the processing.

Therefore, in a printer with two printing units, when the two printing units execute printing simultaneously, slow down the speeds of the two printing units. Normally a printing unit conveys paper through rotary force of a motor, thus slowing down the printing speed further to restrain the power consumption of the motor. Moreover, in a thermal head, a resistor body (a heating body) transforms the electrical energy to the heating when the power is supplied, thus requiring a plurality of electric current when the power is on. But in the thermal head, regardless of the printing speed being fast or slow, in order to form a 1-shaped point, the power-on time of the resistor body substantially does not vary, therefore, by slowing down the printing speed, the number of the 1-shaped points formed in a given time is decreased, further decreasing the total quantity of power-on electricity. That is, by slowing down the printing speed, the power consumption of sprinting unit may be decreased in a given time.

In addition, the thermal head as mentioned above executes printing with the resistor body power-on, thereby the quantity of the consumed power varies according to the number of the simultaneous power-on resistor bodies (below, named printing ratio). Moreover, the power-on time varies according to the temperature of the thermal head itself or the surrounding temperature. Therefore the embodiment is illustrated by the two speeds being the speed 1 and the speed 2 of the first printing unit 3 in way of example, but on account of the printing ratio, the temperature of the thermal head or the surrounding temperature, the printing speed varies, thus an effective printing may be executed.

This embodiment is illustrated by slowing down each printing speed of the two printing units in way of example, but not limited to this, or by slowing down the printing speed of either. Here, it is allowed to slow down such as the printing speed of the printing unit which has the faster printing speed of the two printing units, or to slow down the printing speed of the printing unit with higher power consumption when the power consumptions of the two printing units are largely different. Moreover, the number of the printing units is not limited to two, it may be three or more, thereby changing the printing speed of all these printing units or changing the printing speed of one or two printing units. Moreover, the embodiment is illustrated by adopting an apparatus which utilizes a power supply apparatus 2 to provide power to two printing units and a control unit, but the apparatus may also explained that in which a common power supply provides power to printing units and another power supply provides power to a control unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer, comprising:
a multiple printing units;
a power supply configured to provide power to the multiple printing units; and
a printing control unit configured to execute printing in the speed of being that at least one printing unit slower than the fastest printing speed thereof, when the multiple printing units executes printing simultaneously.

2. The printer according to claim 1, wherein
the printing control unit configured to execute printing all of the multiple printing units in the speed of being that each printing unit slower than the fastest printing speed thereof, when the multiple printing units executes printing simultaneously.

3. The printer according to claim 1, wherein
the printing control unit configured to execute printing by slowing down the printing speed of the printing unit which has the highest printing speed within the multiple printing units execute printing simultaneously when the fastest speeds of the multiple printing unit are different.

4. The printer according to claim 1, wherein
the multiple printing units include a thermal head respectively and execute a thermal transfer printing or a thermal printing to printing media by these thermal heads.

5. The printer according to claim 1, further comprising:
a control unit configured to accept power supplied by the power supply, wherein
the control unit executes the function of the printing control unit.

6. The printer according to claim 2, further comprising:
a detection unit configured to, detect whether or not the printing of the printing unit is completed; and
a speed recovery unit configured to increase the printing speed of in-printing printers excluding the printer which is detected the completion of printing by detection unit.

7. A printing control method of a printer, comprising:
providing power to a plurality of printing units by a power supply apparatus; and
making the printing speed of at least a printing unit slow such that the printing speed slower than the fastest printing speed thereof, when the multiple printing units executes printing simultaneously.
